(19) United States
(12) Patent Application Publication
(10) Pub. No.: US 2011/0224080 A1
(43) Pub. Date: Sep. 15, 2011

(54) FORMULATION BASED ON MICRONIZED NATURAL CALCITE MINERAL AND MICRONIZED ZEOLITE AS AN ENHANCED PLANT BOOSTER AND MINERAL FERTILIZER

(76) Inventors: Antonio Lelas, Zagreb (HR); Ivica Cepanee, Kriz (HR)

(21) Appl. No.: 13/120,179

(22) PCT Filed: Jul. 2, 2008
(86) PCT No.: PCT/HR2008/000023

§ 371 Date: Jun. 2, 2011

(51) Int. Cl. C05D 3/02; C05G 1/00; C05D 9/02; C05B 7/00; C05C 5/00; A01N 59/00; A01P 21/00

(52) U.S. Cl. 504/124; 71/62; 71/61; 504/119; 71/23; 71/11; 71/54; 71/27; 504/125; 71/34; 71/60; 71/59

(57) ABSTRACT

The present invention is related to a formulation based on (i) micronized natural calcite mineral (MC) of particles size from 500 nm to 5 μm, which contains variable amounts of calcite (CaCO₃), dolomite [CaMg (CO₃)₂], ankerite [Ca (Mg, Fe, Mn, Zn) (CO₃)₂], and quartz (SiO₂); (ii) micronized zeolite of particles size from 500 nm to 5 μm, of general formula (Mⁿ⁺) x/n [(AlO₂) x (SiO₂) y].mH₂O (MZ) wherein Me=Na, K, Ca, Mg, Fe, Zn, Mn, Cu; whereas ratio of silicon to aluminum, y:x is between 1:1 to >10:1; whilst m is number of crystalline water molecules which can be from 0 to >20; and of (iii) one or more additives which, with components (i) and (ii), yiled in the final form of the formulation suitable for practical use: powder; wettable powder; concentrate for suspension; or granules; and/or which enhance basic biological actions of (i). The applications of the formulation result in the following effects: more effective stimulation of photosynthetic process in plants; more efficient stimulation of plant growth; enhanced viability of plants to stresses and diseases; improved absorption of nutrients from calcite mineral itself; improved absorption of nutrients applied through the soil; and especially, increased crop yields.

### THE FIELD OF THE INVENTION

The present invention relates to a formulation based on micronized natural calcite mineral and micronized zeolite which is used as a plant booster and mineral fertilizer.

### SUMMARY OF THE INVENTION

The present invention solves technical problem of producing an improved plant booster and mineral fertilizer based on the formulation comprising:

(i) micronized natural calcite mineral (MC) of particles size from 500 nm to 5 μm, which contains variable amounts of calcite (CaCO₃), dolomite [CaMg(CO₃)₂], ankerite [Ca(Mg, Fe, Mn, Zn)(CO₃)₂], and quartz (SiO₂);
(ii) micronized zeolite (MZ) of particles size from 500 nm to 5 μm, of general formula (Meⁿ⁺)_{x/n}[(AlO₂)ₓ(SiO₂)_{y}].mH₂O, wherein Me=Na, K, Ca, Mg, Fe, Zn, Mn, Cu; whereas ratio of silicon to aluminum, y:x is between 1:1 to 10:1; whilst m is number of crystalline water molecules which can be from 0 to >20; and of
(iii) one or more additives which, with components (i) and (ii), yield in the final form of the formulation suitable for practical use: powder; wettable powder; concentrate for suspension; or granules; and/or which enhance basic biological actions of (i).

The applications of the formulation result in the following effects: more effective stimulation of photosynthetic process in plants; more efficient stimulation of plant growth; enhanced viability of plants to physiological, particularly to dehydrating stress; increased resistance to various plant diseases, e.g. powdery mildew; improved absorption of nutrients from calcite mineral itself; improved absorption of nutrients applied through the soil; and especially increased crop yields.

### THE PRIOR ART

The use of mineral fertilizers is essential for modern agricultural production. The latter are based on macro-nutrients: nitrogen, phosphorus, and potassium; on secondary nutrients: calcium, magnesium, and sulfur; and on micronutrients: iron, zinc, manganese, copper, boron, and molybdenum.

It is known that several factors influence the absorption of nutrients by plants. In the case of proper fertilization, the most important factors are: type of a soil, amount of water available, and pH value of the soil. The deficiencies of nutrients cause different physiological disorders which lead to decreased crop yields, diseases, and other unwanted events.

Calcium (Ca²⁺) is among plant nutrients whose deficiency occurs very often. There exist more than 30 disorders caused by deficiency of calcium [for example see F. Bangerth: Calcium-Related Physiological Disorders of Plants, Ann. Rev. Phytopathol. 17 (1979) 97-122]. These disorders are believed to occur due to inefficient distribution rather than poor calcium uptake. Visual symptoms of calcium deficiency in plants are: death of shoots, abnormally deep-green foliage, premature falling of flowers and buds, and weak stalk.

In the prior art the following methods of calcium fertilization are known:
(i) the addition of lime and/or gypsum to the soil;
(ii) addition of classical superphosphate (mainly Ca(H₂PO₄)₂) or triple superphosphate (Ca(H₂PO₄)₂ without gypsum) to the soil;
(iii) addition of calcium nitrate (Ca(NO₃)₂.4H₂O) to the soil or by foliar application; and
(iv) by foliar application of aqueous solution of simple calcium salts (e.g. CaCl₂ or Ca(CH₃COO)₂.xH₂O) or complexes (Na₂CaEDTA or Ca(LigSO₃)₂ where EDTA=ethylenediamine tetraacetic acid, and Lig=lignin residue).

Zeolites are a class of aluminosilicates of general formula (Meⁿ⁺)_{x/n}[(AlO₂)ₓ(SiO₂)_{y}].mH₂O wherein Me represents metal cation such as sodium (Na⁺), potassium (K⁺), magnesium (Mg²⁺), or calcium (Ca²⁺); whereas ratio of silicon to aluminum, y:x can vary between 1:1 to >100:1; whilst m is number of crystalline water molecules which can be from 0 to >20. Structurally, zeolite aluminosilicate structure is three-dimensional skeleton made of SiO₄ and AlO₄ tetrahedra closing micro-(2-20 Å), meso-(20-50 Å), and macro-(50-100 Å) pores.

Zeolites are widely used in industry and medicine as adsorbents, filter-aids, ion-exchangers, catalysts, and as active cosmetic and pharmaceutical substances [R. T. Yang: Adsorbents, Fundamentals and Applications, John Wiley&Sons. Inc. (2003); K. Pavelić, Medical News 26 (1998) 21-22]. Since zeolites are ion-exchangers and can keep water into the pores, zeolites are employed in agriculture as soil improvers, or as artificial soils [for example see EP0444392B1 (T. Loidelsbacher)].

At classical calcium fertilization with superphosphates, the problem is poor bioavailability of calcium. In contrast, calcium fertilizers which are smoothly soluble in water such as calcium salts; Ca(NO₃)₂, CaCl₂, Ca(CH₃COO)₂.xH₂O, or calcium complexes; Na₂CaEDTA, Ca(LigSO₂)₂ where EDTA=ethylenediamine tetraacetic acid, and Lig=lignin residue; have fast and effective action but cannot insure complete calcium fertilization. In the case of more intensive application, significant losses of these products occur due to washing-off from the foliage by rain.

The important and unsolved technical problem yet is how to achieve the effective additional foliar calcium fertilization in such form that is hardly washable from the leaf-surface, but in the same time easily available to the plant.

This can be achieved with the present invention by employing the synergy effect between the micronized calcite (MC) already known from the prior art [PCT/HR2008/000003—Novatech d.o.o] and the micronized zeolite (MZ) thanks to the fact that micronized zeolite (MZ) do act as enhancer of basic boosting effect of micronized calcite itself.

### DETAILED DESCRIPTION OF THE INVENTION

The present invention relates to the formulation based on:

(i) micronized natural calcite mineral (MC) of particles size from 500 nm to 5 μm, which contains variable amounts of calcite (CaCO₃), dolomite [CaMg(CO₃)₂], ankerite [Ca(Mg, Fe, Mn, Zn)(CO₃)₂], and quartz (SiO₂);
(ii) micronized zeolite (MZ) of particles size from 500 nm to 5 μm, of general formula (Meⁿ⁺)_{x/n}[(AlO₂)ₓ(SiO₂)_{y}].mH₂O, wherein Me=Na, K, Ca, Mg, Fe, Zn, Mn, Cu; whereas ratio of silicon to aluminum, y:x is between 1:1 to >10:1; whilst m is number of crystalline water molecules which can be from 0 to >20; and of
(iii) one or more additives which, with components (i) and (ii), yield in the final form of the formulation suitable for practical use: powder; wettable powder; concentrate for suspension; or granules; and/or which enhance basic biological actions of (i).

### Preparation and Characterization of Micronized Natural Calcite Mineral and Micronized Zeolite

The calcite mineral is mined at several locations in Croatia and Bosnia and Herzegovina. Beside calcite phase (CaCO₃), it contains quartz (SiO₂), and calcite-related minerals ankerite [Ca(Mg, Fe, Mn, Zn)(CO₃)₂] and dolomite [CaMg(CO₃)₂] in the following ratio:

(i) calcite and calcite-related minerals-85%;
(ii) quartz-15%

This material was subjected to micronization process in micronizer which was a modified version of device described in the prior art [T. Lelas, EP 1316530 (2004)]. This micronizer is consisted of housing with two opposite rotors. Each rotor contains several rings which are installed one between other, which rotate at 21.000 rpm in opposite directions with the same angular speeds. The rings bring several small spades on both sides acting as collision barriers for the material being micronized. The centrifugal forces carry the particles of material from inner to outer rings. In short, this micronizer provides very effective manner of producing mineral material of significantly damaged surface with enhanced mesoporosity by collision of particles of the material being micronized.

Thus obtained product in the form of white to slightly brownish powder was analyzed by atomic absorption spectroscopy giving the following analysis: 32.4% Ca, 2.16% Mg, 0.76% Fe, 0.015% Mn, 0.003% Zn.

Particle size analysis (Zetasizer NanoZS instrument; Malvern instrument) showed that the product was of Gauss-type distribution with maximum peak around 1 μm.

The results of further analyses by electronic microscopy, X-ray diffraction, and fluorescent X-ray spectroscopy were identical to those described in the prior art [PCT/HR2008/000003—Novatech d.o.o.].

Micronized zeolite (MZ) was prepared on the same manner. As starting materials, two zeolites were selected:

(i) natural zeolite clinoptilolite (Me₂Al₂Si₇O₁₈, Me=Na, K or Me′Al₂Si₇O₁₈, Me′=Mg, Ca); and
(ii) synthetic zeolite A [Na₁₂(Al₁₂Si₁₂O₄₈).27H₂O].

Particle size analysis (Zetasizer NanoZS instrument; Malvern instrument) showed that the product was of Gauss-type distribution with maximum peak between 0.8 μm and 1.2 μm.

Alternatively, synthetic zeolite A which is ordinarily in sodium (Na⁺) form, or natural zeolite clinoptilolite which is mainly in calcium form, is converted to desired metal derivative. In this cases, desired metal act as plant nutrient such as: potassium (K⁺), calcium (Ca²⁺), magnesium (Mg²⁺), iron (Fe²⁺/Fe³⁺), zinc (Zn²⁺), manganese (Mn²⁺), or copper (Cu²⁺).

The conversion includes two step procedure:

(i) treatment with suitable acid which yield in acidic (H⁺)-form of zeolite; followed by
(ii) treatment of thus obtained acidic form of zeolite with suitable metal salts furnishing zeolite derivatives of respective metals.

Suitable acid is selected from the group consisting of hydrochloric acid, hydrobromic acid, hydroiodic acid, nitric acid, formic acid, acetic acid, benzenesulfonic acid, p-toluenesulfonic acid, methanesulfonic acid, or mixtures of these acids.

Metal salt suitable for preparation of metal derivatives from hydrogen (H⁺)-form of zeolites is selected from the group consisting of: halogenides, nitrates, acetates, perchlorates, or arylsulfonates of general formula MeX, Me′X₂, or Me″X₃; wherein Me=K; Me′=Mg, Ca, Zn, Cu, Mn, Fe; Me″=Fe; X═Cl, Br, I, NO₃, CH₃COO, ClO₄, or ArSO₃ like p-CH₃C₆H₄SO₃.

It is clear to those skilled in the art that the present invention includes the use of similar zeolites such as: faujasite (KNa₁₃Ca₁₁Mg₉Al₅₅Si₁₃₇O₃₈₄.235H₂O); chabazite (Ca₆Al₁₂Si₂₄O₇₂.H₂O); gmelinite [(Na₂Ca)₄Al₆Si₁₆O₄₈.24H₂O]; zeolite ZK-4 [Na_{9.2}(Me₄N)_{0.8}(Al₁₀Si₁₄O₄₈), Me=CH₃]; analcime [Naₓ(AlₓSi₄₆₋ₓO₉₆).16H₂O, x=15-17]; zeolite Linde type F [K₁₀(Al₁₀Si₁₀O₄₀).nH₂O, n˜8]; zeolite Linde type X [Na₈₆Al₈₆Si₁₀₆O₃₈₄.nH₂O, n˜260]; zeolite Linde type Y [Na₅₆(Al₅₆Si₁₃₆O₃₈₄).250H₂O]; zeolite ZSM-35 [Na₅(Al₅Si₃₁O₇₂).nH₂O]; zeolite P [Na₇(Al₇Si₉O₃₂)]; zeolite ZSM-35 [Na₅(Al₅Si₃₁O₇₂).nH₂O, n˜18]; zeolite ZK-5 [K₂₂(Al₂₂Si₇₄O₁₉₂).nH₂O, n>1700]; zeolite Linde type L [K₉(Al₉Si₂₇O₇₂).nH₂O, n=0-36]; zeolite Linde type W [K₁₁(Al₁₁Si₂₁O₆₄).20H₂O]; mordenite [Na₅(Al₅Si₄₃O₉₆).nH₂O]; zeolite ZSM-23 [Na(AlSi₂₃O₄₈).nH₂O, n˜4]; zeolite Linde type T [Na_{2.9}K_{5.4}(Al_{8.3}Si_{27.7}O₇₂).nH₂O, n˜7]; ofretite [Na_{0.2}K_{0.9}(Al₄Si₁₄O₃₆).nH₂O, n>1200]; philipsite [Na_{0.9}K_{3.1}(Al₄Si₁₂O₃₂).nH₂O, n>1200]; sodalite [Na₆(Al₆Si₆O₂₄)]; other related zeolites; their sodium (Na⁺), potassium (K⁺), calcium (Ca²⁺), magnesium (Mg²⁺), iron (Fe²⁺/Fe³⁺), zinc (Zn²⁺), manganese (Mn²⁺), or copper (Cu²⁺) derivatives; or mixtures of these substances.

### Application and Mechanisms of Action

In the prior art there was described a profound bioactive action of micronized natural calcite mineral (MC) yielding the following effects [PCT/HR2008/000003—Novatech d.o.o.]:

(i) increased crop yields;
(ii) boosting of plant growth through stimulation of photosynthesis;
(iii) enhanced plant resistance to stress and diseases;
(iv) effective nutrition of plants with calcium, magnesium, iron, manganese, etc.; and
(v) increased efficiency of basic fertilization through soil.

Unexpectedly, we have found that micronized zeolite (MZ) do act as an enhancer of basic biological effects of micronized calcite mineral (MC) itself.

Several studies in the experimental fields have been performed in order to proof a synergistic and enhancing action of micronized zeolite (MZ) on valuable above-mentioned basic biological effects of micronized calcite mineral (MC).

In all studies performed, the following model formulation was employed:

25% micronized natural calcite mineral (MC)
25% micronized natural zeolite clinoptilolite (MZ; mainly in Ca²⁺ form)
0.5% 2-hydroxyethylcellulose (as suspension stabilizer)
49.5% water.

As the control, the following variant of model formulation from the prior art was used:

25% micronized natural calcite mineral (MC)
0.5% 2-hydroxyethylcellulose (as suspension stabilizer)
74.5% water.

The studies were carried out on wheat, potato, sugar beet, lettuce, celery, cucumbers, tomato, and grape.

The results of these studies showed several positive effects in crops which were, beside MC, treated with MZ (Table 1).

TABLE 1

| No. | Culture | Application¹ | Achieved effect |
|---|---|---|---|
| 1 | Wheat | 2 × 8 kg/ha | increased crop yield (+6)² |
| 2 | Potato | 2 × 8 kg/ha | increased crop yield (+6 to +10.5%),² |
| | | | increased resistance to plant diseases |
| 3 | Sugar beet | 1 × 8 kg/ha | increased crop yield (+6.5%),² |
| | | | increased sugar content (+11%) |
| 4 | Lettuce | 3 × 8 kg/ha | increased crop yield (+4 to 11%),² |
| | | | increased dry matter (+12%), |
| | | | slightly improved stability during |
| | | | storage |
| 5 | Celery | 3 × 8 kg/ha | increased crop yield (+9.5%)² |
| 6 | Cucumbers | 3 × 8 kg/ha | increased crop yield (+11%),² |
| | | | increased resistance to fungi |
| | | | diseases |
| 7 | Tomato | 3 × 8 kg/ha | increased crop yield (+14%)² |
| 8 | Grape | 3 × 8 kg/ha | increased crop yield (+6 to +10%),² |
| | | | slightly increased sugar content, |
| | | | improved resistance of plant to stress |
| | | | and fungi diseases |

¹All foliar applications of both the formulation from the present invention as well as the control formulation from the prior art were conducted in evening time.
²Increased crop yields (%) of tested crops from experimental parcels versus yields of the same crops from parcels treated with micronized calcite only (without micronized zeolite).

From these results it is clear to those skilled in the art that micronized zeolite (MZ) do act as enhancer of basic plant boosting action of micronized calcite mineral (MC) itself.

The plants treated with the formulation of the present invention which, beside MC, contained also MZ, resulted in unexpectedly increased crop yields, from +4% to +14%, obviously due to:

(i) enhanced boosting of plant growth through highly stimulated photosynthesis;
(ii) improved resistance of plants to stress and diseases;
(iii) improved nutrition with calcium, magnesium, iron, manganese, zinc, silicon, etc.; and
(iv) improved uptake of nutrients applied through basic soil fertilization.

Obviously, micronized zeolite (MZ) acts as an enhancer of all basic biological effects of micronized calcite (MC).

It can be speculated that micronized zeolite (MZ) after foliar application is being incorporated into the waxy layer on the surface of the leaf. In this manner it acts as a “channel” for alleviate transport of cationic nutrients into the leaf.

Leaf surface wax is a natural barrier which protects a leaf from too excessive loss of water through transpiration. However, in the same time it makes troublesome transport (absorption) of nutrients into the leaf. Leaf wax is consisting of esters of higher fatty acids (including hydroxy acids) with higher fatty alcohols. Minor ingredients are free higher fatty acids and alcohols, and higher fatty hydroxy acids.

Zeolite can forms Lewis acid-Lewis base-type bonds with waxy layer on the leaf. In this case, cations (e.g. Ca²⁺) from the zeolite plays the role of Lewis acids, whereas hydroxyl groups of higher fatty acids or even ester groups of the wax act as Lewis bases sites.

Such bounded zeolite particles can act as “ion-channels” allowing easier entrance of metal cations from surface of the leaf through the waxy layer into the leaf. These are released after dissolution of micronized calcite mineral (MC) in slightly acidic media (pH around 5.8) on the surface of the leaf.

The synergistic effect of micronized zeolite (MZ) on absorption of metal cations (nutrients: K⁺, Ca²⁺, Mg²⁺, Fe²⁺/Fe³⁺, Zn²⁺, Mn²⁺, Cu²⁺) is schematically given bellow (Scheme 1):

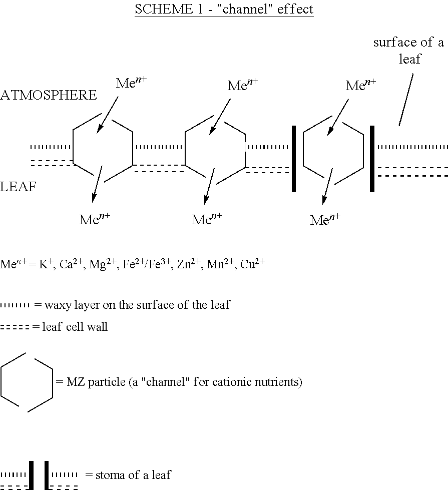

The above proposed mechanism of enhancing effect of micronized zeolite (MZ) on absorption of micronized calcite (MC) is compatible with modern knowledge of nutrient absorption through leaf [P. Wójcik: Uptake of Mineral Nutrients from Foliar Fertilization, J. Fruit Ornamental Plant Res. 12 (2004) 210-218].

The second possible mechanism of synergistic and enhancing action of micronized zeolite (MZ) on basic effects of micronized calcite mineral (MC) includes alleviated uptake of silicon dioxide (SiO₂), presumably in the form of ortho-silicic acid (H₄SiO₄). As mentioned above, natural calcite mineral (MC) used in these studies contained typically around 15% of natural quartz. The latter, in micronized form (particles size are around 1 μm) exhibits significantly increased water solubility what is well known in the prior art [C. C. Lucas, M. E. Dolan: Studies on the Solubility of Quartz and Silicates, Can. Med. Assoc. J. (1939) 126-134].

Monomeric ortho-silicic acid (H₄SiO₄) which is generated by equilibrium dissociation of quartz (SiO₂) in water can more easily enter into the leaf through micropores of zeolite particles anchored in the hydrophobic waxy layer on the surface of the leaf.

In this manner, ortho-silicic acid (originating from natural calcite mineral, also in micronized SiO₂ form) become highly bioavailable for the plant metabolism. According to the prior art, it is known that several mentioned effects which have been observed in experimental fields by using the formulation of this invention can be explained by effects of highly bioavailable silicon [in the form of H₄SiO₄; for example see: J. F. Ma, N. Yamaji: Silicon Uptake and Accumulation in Higher Plants, Trends Plant Sci. 11 (2006) 392-397].

Except alleviated transport of plant nutrients, the layer of micronized zeolite (MZ) on the surface of the leaf protects the plant from dehydration through excessive transpiration. It is known that zeolites usually contain approx. 5-15% water in micro-, meso-, and macro-pores of their structure. In this manner, zeolites act as reservoir of water during dry weather conditions. Thus, zeolites help better water management, what in connection with other measures, bring to increased crop yields what were really demonstrated in several agricultural crops, indeed.

The formulation of the present invention can be applied by:

(i) powdering of leaves and stalks;
(ii) foliar treatment (spraying) of its aqueous suspension in concentrations from 0.1-5% calculated on the content of natural calcite mineral (MC).

In the first case, the formulation of this invention can be in the form of powder, whereas in the second case, wettable powder, concentrate for suspension, or granules are more preferred versions of the formulation.

### Composition of the Formulation According to the Invention

The formulation of the present invention is consisting of:

(i) micronized natural calcite mineral (MC) of particle size from 500 nm to 5 μm, which contains variable amounts of calcite (CaCO₃), dolomite [CaMg(CO₃)₂], ankerite [Ca(Mg, Fe, Mn, Zn)(CO₃)₂], and quartz (SiO₂); in amounts from 10% to 80%, most preferably from 30-60%, of the following chemical compositions (expressed as the content of corresponding metal oxides):
—CaO, from 10% to 50%,
—MgO, from 0.1% to 25%,
—Fe₂O₃, from 0.1% to 25%,
—MnO, from 0.001% to 5%,
—ZnO, from 0.001% to 5%,
—SiO₂, from 0.1% to 25%;
(ii) micronized zeolite (MZ) of particle size from 500 nm to 5 μm, of general formula (Meⁿ⁺)_{x/n}[(AlO₂)ₓ(SiO₂)_{y}].mH₂O, wherein Me=Na, K, Ca, Mg, Fe, Zn, Mn, Cu; whereas ratio of silicon to aluminum, y:x is between 1:1 to >10:1; whilst m is number of crystalline water molecules which can be from 0 to >20; in amounts from 10% to 80%, most preferably from 30-60% and of
(iii) one or more additives which, with components (i) and (ii), yield in the final form of the formulation suitable for practical use: powder; wettable powder; concentrate for suspension; or granules; and/or which enhance basic biological actions of (i); in amounts of 0.0001% to 60%, most preferably from 0.0001% to 50%.

Possible kinds of micronized zeolites and micronized calcite mineral that can be used in production of the formulation of this invention have been already described.

The component under (iii)-additive was selected from the groups consisting of: diluents; suspension stabilizers; wetting agents; drift-control agent at applications by spraying; humic acid salts; salts of aminoacids; complexes of plant secondary- and micro-nutrients; vitamins; plant hormones; nitrogen fertilizers; potassium salts; borate salts; molybdate salts; plant extracts; chlorophyll; and yeast extract; or mixtures of these substances.

Additives of the formulation under (iii) can be employed in standard concentrations known for each of these substances:
diluent, most preferably from 10% to 60%,
suspension stabilizer, most preferably from 0.1% to 10%,
wetting agent, most preferably from 2% to 20%,
drift-control agent at application by spraying, most preferably from 0.1% to 5%,
humic acid salt, most preferably from 0.1% to 5%,
salts of amino-acids, most preferably from 0.01% to 10%,
complex of plant secondary- or micro-nutrients, most preferably from 0.01% to 50%,
vitamin, most preferably from 0.0001% to 1%,
plant hormone, most preferably from 0.0001% to 0.1%,
nitrogen fertilizer, most preferably from 1% to 50%,
potassium salt, most preferably from 1% to 50%,
borate salt, most preferably from 0.01% to 50%,
molybdate salt, most preferably from 0.0001% to 5%,
plant extract, chlorophyll, most preferably from 0.01% to 50%,
yeast extract, most preferably from 0.001 to 5%,
   or mixture of two or more above-mentioned additives wherein overall percentage of additives do not exceed 60% of overall composition of the formulation.

It is important to mention that given additives do not chemically react with the carbonate-based compounds from the mineral phase, but together form a compatible formulation.

Diluent is selected from the group consisting of water, ethanol, n-propanol, isopropanol, n-butanol, 1,2-propyleneglycol, hexyleneglycol, glycerol, aqueous sorbitol solutions, polypropyleneglycols, polyglycerols, diethyleneglycol monomethylether; diethyleneglycol dimethylether, diethyleneglycol monoethylether, diethyleneglycol diethylether, triethyleneglycol monomethylether, triethyleneglycol dimethylether, triethyleneglycol monoethylether, triethyleneglycol diethylether, mineral oil, plant oils (triglycerides), isosorbide dimethylether, 2-methyltetrahydrofuran, dimethylsulfoxide, liquid polysorbates, methyl or ethyl esters of higher fatty acids (known as biodiesel), beeswax, carnauba wax, vaseline, paraffin wax, montan wax, ozokerite, or mixtures of these substances.

Suspension stabilizer is selected from the group consisting of polyvinyl alcohol, polyacrylic acid, polyacrylamide, sodium carboxymethylcellulose, methylcellulose, 2-hydroxyethylcellulose, 2-hydroxypropylcellulose, starch, modified starches, sodium starch glycolate, dextrins, modified dextrins, polylactic acid, polyethyleneglycol 400, polyethyleneglycol 600, polyethyleneglycol 1000, polyethyleneglycol 2000, polyethyleneglycol 4000, polyethyleneglycol 6000, polypropyleneglycols, polyglycerols, polyvinylpyrrolidone, polyvinylpyrrolidone co-polymers, guar gum, sodium alginate, agar, carrageenan, pectin, gum arabic, bentonite, montmorillonite, silica gel, clays, talc, kaolin, or mixtures of these substances.

Wetting agent is selected from the group consisting of di-1-p-menthene, polymers of 1-p-menthene, sodium bis(2-ethylhexyl)sulfosuccinate, potassium bis(2-ethylhexyl)sulfosuccinate, disodium (2-ethylhexyl)sulfosuccinate, dipotassium (2-ethylhexyl)sulfosuccinate, nonylphenol(9) ethoxylate, polyoxyethylene(2) laurylether, polyoxyethylene(10) laurylether, polyoxyethylene(20) laurylether, polyoxyethylene(2) myristylether, polyoxyethylene(10) myristylether, polyoxyethylene(20) myristylether, polyoxyethylene(2) stearylether, polyoxyethylene(10) stearylether, polyoxyethylene(20) stearylether, polyoxyethylene(2) oleylether, polyoxyethylene(10) oleylether, polyoxyethylene(20) oleylether, polyoxyethylene laurate, polyoxyethylene myristate, polyoxyethylene stearate, polyoxyethylene oleate, polyoxyethylene(20) sorbitan monolaurate, polyoxyethylene sorbitan monopalmitate, polyoxyethylene sorbitan monostearate, polyoxyethylene sorbitan monooleate, polyoxyethylene sorbitan trioleate, polyoxyethylene sorbitan tristearate, polyoxyethylene sorbitan sesquioleate, laurylamide, stearylamide, lauryl monoethanolamide, lauryl diethanolamide, sodium dodecylsulfate, potassium dodecylsulfate, sodium dodecylbenzenesulfonate, potassium dodecylbenzenesulfonate, sodium lauryldiethyleneglycolsulfate, potassium lauryldiethyleneglycolsulfate, sodium lauryltriethyleneglycolsulfate, potassium lauryltriethyleneglycolsulfate, sodium laurate, potassium laurate, ammonium laurate, sodium myristate, potassium myristate, ammonium myristate, sodium palmitate, potassium palmitate, ammonium palmitate, sodium stearate, potassium stearate, ammonium stearate, sodium oleate, potassium oleate, ammonium oleate, sodium ricinoleate, potassium ricinoleate, ammonium ricinoleate, sodium 2-ethylhexanoate, potassium 2-ethylhexanoate, ammonium 2-ethylhexanoate, or mixtures of these substances.

The drift-control agent at application by spraying is selected from the group consisting of polyvinyl alcohol, polyacrylic acid, polyacrylamide, sodium carboxymethylcellulose, methylcellulose, 2-hydroxyethylcellulose, 2-hydroxypropylcellulose, starch, modified starches, sodium starch glycolate, dextrins, modified dextrins, polylactic acid, polyethyleneglycol 2000, polyethyleneglycol 4000, polyethyleneglycol 6000, polypropyleneglycols, polyglycerols, polyvinylpyrrolidone, guar gum, sodium alginate, agar, carrageenan, pectin, gum arabic, or mixtures of these substances.

Humic acid salt is selected from the group consisting of sodium humate, potassium humate, calcium humate, magnesium humate, iron humate, manganese humate, zinc humate, copper humate, or mixtures of these substances.

Salts of amino-acids are selected from the group consisting of sodium, potassium, ammonium, calcium, or magnesium salts of amino-acids: glycine, alanine, valine, leucine, isoleucine, phenylglycine, phenylalanine, methionine, cysteine, cystine, glutamic acid, glutamine, asparaginic acid, asparagine, tyrosine, serine, proline, threonine, lysine, tryptophan, or mixtures of these substances.

Complex of plant secondary- and micro-nutrients is selected from the group consisting of metal ethylenediamine tetraacetates of general formula Me₂M(EDTA); metal N-(2-hydroxyethyl)ethylenediamine triacetates of general formula MeM(HEDTA); metal diethylenetriamine pentaacetates of general formula MeM₂(DTPA); citrate complexes of general formula MeM(C(OH)(COO)(CH₂COO)₂); and lignosulfonates of general formula Me(LigSO₃)₂; where Me=Na, K, NH₄; M=Ca, Mg, Fe, Mn, Zn, Cu; EDTA=ethylenediamine tetraacetic acid; HEDTA=N-(2-hydroxyethyl)ethylenediamine triacetic acid; DTPA=diethylenetriamine pentaacetic acid; and Lig=lignin moiety; or mixtures of these complexes.

The vitamin is selected from the group consisting of: riboflavin; thiamin; nicotinic acid; nicotinamide; pantothenic acid; pyridoxine; ascorbic acid; biotin; tocoferol; vitamin K₁; vitamin K₂; menadione; their sodium, potassium, calcium, magnesium, or ammonium salt; or their derivatives which by hydrolysis give starting vitamin; or mixtures of these substances.

The plant hormone is selected from the group consisting of: 2-(indol-3-yl)acetic acid; 2-(naphthalene-1-yl)acetic acid; 4-(indol-3-yl)butyric acid; abscisic acid; giberelinic acids; their ammonium, sodium, potassium, calcium or magnesium salts; zeatin; or mixtures of these substances.

The nitrogen fertilizer is selected from the group consisting of urea, ammonium hydrogenphosphate, sodium nitrate, or mixtures of these substances.

Potassium salt is selected from the group consisting of potassium nitrate, potassium hydrogenphosphate, potassium chloride, potassium sulfate, potassium magnesium sulfate, potassium thiosulfate, or mixtures of these substances.

Borate salt is selected among classical boron fertilizers such as sodium borate, potassium borate, sodium tetraborate, potassium tetraborate, their hydrates, or mixtures of these substances.

Molybdate salt is selected from the group consisting of sodium molybdate, potassium molybdate, their hydrates, or mixtures of these substances.

The plant extract is selected from the group consisting of: plant extracts of nettle, wheat, oat, barley, soybean, corn, seaweed; chlorophyll; or mixtures these substances as inexpensive and readily available, and in the same time rich natural sources of minerals, vitamins, plant hormones, carbohydrates, essential higher fatty acids, amino-acids and proteins which are useful for plants.

The formulation of this invention can be produced by homogenization of micronized calcite mineral (MC), and micronized zeolite (MZ) eventually with addition of one or more adjuvants according to procedures well known to those skilled in the art. After homogenization, the product can be processed by granulation into this kind of formulation [for example see V. Sauchelli: Chemistry and Technology of Fertilizers, ACS Monograph Series, Reinhold].

### EXAMPLES

### General Information

In the following examples of testing of the formulation on experimental fields, an aqueous suspension of the formulation was employed. The latter was prepared by dilution of concentrate for suspension in ordinary tap water. The composition of the formulation in the form of this concentrate for suspension was as follows:

25% micronized natural calcite mineral (MC)
25% micronized zeolite clinoptilolite (MZ)
0.5% 2-hydroxyethylcellulose
49.5% water

Preparation of this model formulation is described in Example 3. The concentrate for suspension was used in concentration of 4%, meaning 1% of micronized natural calcite mineral (MC) in employed spraying (ready-for-use) suspension.

### Example 1

### Preparation of Powder with 50% of Micronized Natural Calcite Mineral (MC) and 50% of Micronized Zeolite (MZ)

Composition (1 kg of powder): (a) Micronized natural calcite mineral (MC; 500.00 g; 50%), (b) micronized zeolite clinoptilolite (MZ; 500.00 g; 50%).

Preparation: (a) and (b) was weighted and added into the homogenizer. The homogenization was continued for 15 minutes. Thus obtained product was in the form of white or pale brown to pale greenish powder.

### Example 2

### Preparation of Wettable Powder with 50% of Micronized Natural Calcite Mineral (MC) and 45% of Micronized Zeolite (MZ)

Composition (1 kg of wettable powder): (a) Micronized natural calcite mineral (MC; 500.00 g; 50%), (b) micronized zeolite clinoptilolite (MZ; 450.00 g; 45%), (c) micronized bentonite (20.00 g; 2%), (d) 2-hydroxyethylcellulose (10.00 g; 1%), (e) nonylphenol(9) ethoxylate (20.00 g; 2%).

Preparation: To 1000 mL of demineralized water, (d) was added and dissolved by stirring at 45-50° C. during 1 h yielding colorless viscous solution. To thus obtained solution, (c) and (e) were added and stirring was continued at room temperature during 15 minutes. Then, (a) and (b) were added, and the mixture was stirred at room temperature during 15 minutes. This product was evaporated to dryness giving white or pale brown to pale greenish fine powder.

This wettable powder in working concentrations from 1% to 10% (0.5-5% of MC) can be easily suspended in water yielding milky, slightly brownish to greenish suspension of acceptable stability for use in ordinary spraying equipments.

### Example 3

### Preparation of Concentrate for Suspension with 25% of Micronized Natural Calcite Mineral (MC) and 25% of Micronized Zeolite (MZ)

Composition (1 kg of concentrate for suspension): (a) Micronized natural calcite mineral (MC; 250.00 g; 25%), (b) micronized zeolite clinoptilolite (MZ; 250.00 g; 25%), (c) 2-hydroxyethylcellulose (5.00 g; 0.5%), (d) demineralized water (495.00 g; 49.5%).

Preparation: In (d), (c) was added and dissolved by mixing at 45-50° C. during 1 h forming colorless viscous solution. To thus prepared solution, (a) and (b) were added, and stirred at room temperature during 15 minutes. The product was in the form of stable, viscous slightly brownish suspension.

The product can be easily diluted with ordinary tap water at concentrations from 0.5% to 20% (0.125-5% of MC) giving the suspension of considerable stability suitable for direct use in ordinarily spraying equipments.

### Example 4

### Preparation of Granules with 50% of Micronized Natural Calcite Mineral (MC) and 40% of Micronized Zeolite (MZ)

Composition (1 kg of granules): (a) Micronized natural calcite mineral (MC; 500.00 g; 50%), (b) micronized synthetic zeolite A (MZ; 400.00 g; 40%), (c) micronized bentonite (40.00 g; 4%), (d) 2-hydroxyethylcellulose (10.00 g; 1%), (e) nonylphenol(9) ethoxylate (50.00 g; 5%).

Preparation: To 2000 mL of demineralized water, (d) was added, and dissolved by stirring at 45-50° C. during 1 h yielding colorless viscous solution. To thus prepared solution, (e) and (c) were added, and stirred at room temperature during 15 minutes. Then, (a) and (b) were added, and homogenization was continued for 15 minutes. In this way, stable viscous greenish to pale brown suspension was obtained.

This product was subjected to spray-drying to give white-greyish to pale greenish granules. Dusting tendencies were not observed.

This product can be easily dissolved in water at concentrations from 0.5% to 10% (0.25-5% of MC) furnishing white-brownish to pale greenish suspension of respective stability for use in ordinarily spraying equipments.

### Example 5

### The Use of the Concentrate for Suspension Containing 25% of Micronized Calcite Mineral (MC) and 25% of Micronized Zeolite (MZ) as a Plant Booster and Mineral Fertilizer in Production of Wheat

The model formulation of this invention described in Example 3 was used in a controlled study in production of wheat. The test included two foliar treatments with 4% of the formulation at amounts of 8 kg/ha (2×2 kg/ha calculated on the content of MC), each 15 days. In comparison with the control parcel treated with MC only (2×2 kg/ha), significantly increased wheat yield was obtained (+6%) from the test parcel.

Also, fairly better stress resistance (high temperatures and water deficiencies) was found. Further increasing of stalk hardiness has not been observed.

### Example 6

### The Use of the Concentrate for Suspension Containing 25% of Micronized Calcite Mineral (MC) and 25% of Micronized Zeolite (MZ) as a Plant Booster and Mineral Fertilizer in Production of Potato

The formulation from this invention described in Example 3 was tested as a plant booster and mineral fertilizer in production of potato. The following potato varieties were tested: Ostara, Agatha, and Charlotte. Three foliar treatments of these potato varieties at amounts of 8 kg/ha (2 kg/ha; calculated on the content of MC), each 15 days were carried out. In this study the control parcels were treated with micronized calcite mineral (MC) only (3×2 kg/ha). In comparison with the crop yields in control parcels, yields from the test parcels were significantly increased: +10% (Ostara), +6% (Agatha), and 7.8% (Charlotte).

### Example 7

### The Use of the Concentrate for Suspension Containing 25% of Micronized Calcite Mineral (MC) and 25% of Micronized Zeolite (MZ) as a Plant Booster and Mineral Fertilizer in Production of Sugar Beet

The formulation of the present invention (see Example 3) was tested as a plant booster and mineral fertilizer in production of sugar beet. One foliar treatment with 4% suspension of the formulation at 8 kg/ha (2 kg/ha calculated on the content of MC) was performed. In this study the control parcel was treated with micronized calcite mineral (MC) only (2 kg/ha). Fairly increased crop yield, for 6.5%, with significantly increased (+11%) sugar content was obtained.

### Example 8

### The Use of the Concentrate for Suspension Containing 25% of Micronized Calcite Mineral (MC) and 25% of Micronized Zeolite (MZ) as a Plant Booster and Mineral Fertilizer in Production of Lettuce

The formulation from this invention (Example 3) was used as a plant booster and mineral fertilizer in production of lettuce. The following lettuce varieties were tested: Atria, Oak leaf, and Esttele. In this study the control parcels were treated with micronized calcite mineral (MC) only (3×2 kg/ha). In contrast, three foliar treatments with 4% suspension of the formulation at 8 kg/ha (2 kg/ha calculated on the content of MC), each 14 days, resulted in increased yields in all lettuce varieties tested: +11% (Atria), +9% (Oak leaf), and +4% (Esttele).

Stability of lettuce during storage, which was improved due to treatments even with MC itself, was also additionally improved to a certain extent. The latter improvement was presumably achieved due to significant increasing of dry matter content of the crop (+12%).

### Example 9

### The Use of the Concentrate for Suspension Containing 25% of Micronized Calcite Mineral (MC) and 25% of Micronized Zeolite (MZ) as a Plant Booster and Mineral Fertilizer in Production of Celery

The formulation from this invention (Example 3) was used as a plant booster and mineral fertilizer in production of celery. The test parcel was treated with 3×8 kg/ha (3×2 kg expressed on the content of MC) of the formulation, each 14 days. In this study the control parcel was treated with micronized calcite mineral (MC) only (3×2 kg/ha).

This study the crop yield from treated parcel, in comparison with the control parcel, was increased for 9.5%.

### Example 10

### The Use of the Concentrate for Suspension Containing 25% of Micronized Calcite Mineral (MC) and 25% of Micronized Zeolite (MZ) as a Plant Booster and Mineral Fertilizer in Production of Cucumbers

The formulation from this invention was used as a plant booster and mineral fertilizer in production of cucumbers. The test parcel was treated with 3×8 kg/ha (3×2 kg of MC) of the formulation, each 14 days. The control parcel was treated with micronized calcite mineral (MC) only (3×2 kg/ha).

In comparison to the crop yield from the control parcel, the crop yield from the test parcel was improved for 11%. The plants in the test parcel were obviously of enhanced resistance to fungi diseases.

### Example 11

### The Use of the Concentrate for Suspension Containing 25% of Micronized Calcite Mineral (MC) and 25% of Micronized Zeolite (MZ) as a Plant Booster and Mineral Fertilizer in Production of Tomato

A controlled study of the formulation of this invention (Example 3) was carried out in production of tomato. In the control parcel, only micronized calcite mineral (MC) was used (without micronized zeolite). The study included three treatments at 8 kg/ha (corresponds to 3×2 kg/ha of MC), each 14 days, by spraying with 4% suspension of the formulation.

From the parcel treated with the formulation of the present invention, significantly increased (+14%) tomato yield was obtained.

Also, not less important, slightly improved resistance to fungi diseases was observed.

### Example 12

### The Use of the Concentrate for Suspension Containing 25% of Micronized Calcite Mineral (MC) and 25% of Micronized Zeolite (MZ) as a Plant Booster and Mineral Fertilizer in Production of Grape

The formulation from this invention (Example 3) was used as a plant booster and mineral fertilizer in production of grape. The tested grape varieties were Chardonnay and Merlot. The test parcel was treated with 3×8 kg/ha (3×2 kg of MC) of the formulation, each 14 days. The control parcels were treated with micronized calcite mineral (MC; 3×2 kg/ha) only.

In comparison with control parcels treated with MC only, the crop yields from the testing parcels were fairly increased, for 6% (Chardonnay) and 10% (Merlot).

Additionally, slightly increased sugar contents were observed. Also, parcels treated with combination of MC+MZ obviously showed better resistance to stress conditions (high temperatures, water deficiencies) and diseases (powdery mildew) than parcels treated with MC only.

### APPLICABILITY OF THE INVENTION

From performed examples of the use of representative formulation of this invention as a plant booster and mineral fertilizer in production of wheat, potato, sugar beet, lettuce, celery, cucumbers, tomato, and grape, it can be concluded that the formulation allows significantly increased yields of these agricultural crops, which are not expected from the prior art by using micronized calcite mineral only.

1. A formulation based on micronized natural calcite mineral and micronized zeolite as an enhanced plant booster and mineral fertilizer, the formulation comprising:
a micronized natural calcite mineral (MC) comprising a first plurality of particles having a size ranging from approximately 500 nm to approximately 5 μm, the micronized natural calcite mineral containing variable amounts of calcite (CaCO₃), dolomite [CaMg(CO₃)τ], ankerite [Ca(Mg, Fe, Mn, Zn)(CO₃)₂], and quartz (SiO₂);
a micronized zeolite (MZ) comprising a second plurality of particles having a size ranging from approximately 500 nm to approximately 5 μm, of general formula (Meⁿ⁺)_{xΛ1}[(AlO₂)ₓ(SiO₂)_{y}]′HiH₂O wherein Me comprises at least one of Na, K, Ca, Mg, Fe, Zn, Mn, or Cu;
wherein a ratio of silicon to aluminum is between 1:1 to >10:1;
wherein a number of crystalline water molecules is in the range from approximately 0 to greater than 20; and
at least one additive which, together with the micronized natural calcite mineral and the micronized zeolite, yield at least one of: a powder; a wettable powder; a concentrate for suspension; or granules which enhance basic biological actions of the micronized natural calcite mineral.

2. The formulation according to claim 1, wherein the at least one additive is selected from the group consisting of a diluent; a suspension stabilizer; a wetting agent; a drift-control agent; a humic acid salt; a salt of aminoacid; a complex of plant secondary- or micro-nutrients; a vitamin; a plant hormone; a nitrogen fertilizer; a potassium salt; a borate salt; a molybdate salt; a plant extract; a chlorophyll; or a yeast extract.

3. The formulation according to claim 1, wherein:
the at least one additive is the diluent; and
the diluent comprises at least one of water, ethanol, n-propanol, isopropanol, Λ-butanol, 1,2˜propyleneglycol, hexyleneglycol, glycerol, aqueous sorbitol solutions, polypropyleneglycols, polyglycerols, diethyleneglycol monomethylether; diethyleneglycol dimethylether, diethyleneglycol monoethylether, diethyleneglycol diethylether, triethyleneglycol monomethylether, triethyleneglycol dimethylether, triethyleneglycol monoethylether, triethyleneglycol diethylether, mineral oil, plant oils (triglycerides), isosorbide dimethylether, 2-methyltetrahydrofuran, dimethylsulfoxide, polysorbates, methyl or ethyl esters of higher fatty acids, beeswax, carnauba wax, vaseline, paraffin wax, montan wax, or ozokerite.

4. The formulation according to claim 1, wherein:
the at least one additive is the suspension stabilizer; and
the suspension stabilizer comprises at least one of polyvinyl alcohol, polyacrylic acid, polyacrylamide, sodium carboxymethylcellulose, methylcellulose, 2-hydroxyethylcellulose, 2-hydroxypropylcellulose, starch, modified starches, sodium starch glycolate, dextrins, modified dextrins, polylactic acid, polyethyleneglycol 400, polyethyleneglycol 600, polyethyleneglycol 1000, polyethyleneglycol 2000, polyethyleneglycol 4000, polyethyleneglycol 6000, polypropyleneglycols, polyglycerols, polyvinylpyrrolidone, polyvinylpyrrolidone co-polymers, guar gum, sodium alginate, agar, carrageenan, pectin, gum arabic, bentonite, montmorillonite, silica gel, clays, talc, or kaolin.

5. The formulation according to claim 1, wherein:
the at least one additive is the wetting agent; and
the wetting agent comprises at least one of di-1-p-menthene, polymers of 1-p-menthene, sodium bis(2-ethylhexyl) sulfosuccinate, potassium bis (2-ethylhexyl) sulfosuccinate, disodium (2-ethylhexyl) sulfosuccinate, dipotassium (2-ethylhexyl) sulfosuccinate, nonylphenol (9) ethoxylate, polyoxyethylene (2) laurylether, polyoxyethylene (10) laurylether, polyoxyethylene (20) laurylether, polyoxyethylene (2) myristylether, polyoxyethylene (10) myristylether, polyoxyethylene (20) myristylether, polyoxyethylene (2) stearylether, polyoxyethylene (10) stearylether, polyoxyethylene (20) stearylether, polyoxyethylene (2) oleylether, polyoxyethylene (10) oleylether, polyoxyethylene (20) oleylether, polyoxyethylene laurate, polyoxyethylene myristate, polyoxyethylene stearate, polyoxyethylene oleate, polyoxyethylene (20) sorbitan monolaurate, polyoxyethylene sorbitan monopalmitate, polyoxyethylene sorbitan monostearate, polyoxyethylene sorbitan monooleate, polyoxyethylene sorbitan trioleate, polyoxyethylene sorbitan tristearate, polyoxyethylene sorbitan sesquioleate, laurylamide, stearylamide, lauryl monoethanolamide, lauryl diethanolamide, sodium dodecylsulfate, potassium dodecylsulfate, sodium dodecylbenzenesulfonate, potassium dodecylbenzenesulfonate, sodium lauryldiethyleneglycolsulfate, potassium lauryldiethyleneglycolsulfate, sodium lauryltriethyleneglycolsulfate, potassium lauryltriethyleneglycolsulfate, sodium laurate, potassium laurate, ammonium laurate, sodium myristate, potassium myristate, ammonium myristate, sodium palmitate, potassium palmitate, ammonium palmitate, sodium stearate, potassium stearate, ammonium stearate, sodium oleate, potassium oleate, ammonium oleate, sodium ricinoleate, potassium ricinoleate, ammonium ricinoleate, sodium 2-ethylhexanoate, potassium 2-ethylhexanoate, or ammonium 2-ethylhexanoate.

6. The formulation according to claim 1, wherein:
the at least one additive is the drift-control additive; and
the drift-control additive comprises at least one of polyvinyl alcohol, polyacrylic acid, polyacrylamide, sodium carboxymethylcellulose, methylcellulose, 2-hydroxyethylcelluloseᵣ 2-hydroxypropylcellulose, starch, modified starches, sodium starch glycolate, dextrins, modified dextrins, polylactic acid, polyethyleneglycol 400, polyethyleneglycol 600, polyethyleneglycol 1000, polyethyleneglycol 2000, polyethyleneglycol 4000, polyethyleneglycol 6000, polypropyleneglycols, polyglycerols, polyvinylpyrrolidone, guar gum, sodium alginate, agar, carrageenan, pectin, or gum Arabic.

7. The formulation according to, wherein:
the at least one additive is the humic acid salt; and
the humic acid salt comprises at least one of sodium humate, potassium humate, calcium humate, magnesium humate, iron humate, manganese humate, zinc humate, or copper humate.

8. The formulation according to claim 1, wherein:
that at least one additive is the salt of amino-acids;
the salt of amino-acids comprises at least one of sodium, potassium, ammonium, calcium, or magnesium; and
the salt of amino-acids comprises at least one of glycine, alanine, valine, leucine, isoleucine, phenylglycine, phenylalanine, methionine, cysteine, cystine, glutamic acid, glutamine, asparaginic acid, asparagine, tyrosine, serine, proline, threonine, lysine, or tryptophan.

9. The formulation according to claim 1, wherein:
the at least one additive is the complex of plant secondary- or micro-nutrients; and
the complex of plant secondary- or micro-nutrients comprises at least one of metal ethylenediamine tetraacetates of general formula Me₂M(EDTA); metal N-(2-hydroxyethyl)ethylenediamine triacetates of general formula MeM(HEDTA); metal diethylenetriamine pentaacetates of general formula MeM2 (DTPA); citrate complexes of general formula MeM(C(OH)(COO)(CH₂COO)₂); and lignosulfonates of general formula Me (LigSO₃)₂;
wherein Me comprises Na, K, or NH₄; M comprises Ca, Mg, Fe, Mn, Zn, or Cu; EDTA comprises ethylenediamine tetraacetic acid; HEDTA comprises N-(2-hydroxyethyl)ethylenediamine triacetic acid; DTPA comprises diethylenetriamine pentaacetic acid; and Lig comprises lignin residue.

10. The formulation according to claim 1, wherein:
the at least one additive is the vitamin;
the vitamin comprises at least one of riboflavin; thiamin; nicotinic acid; nicotinamide; pantothenic acid; pyridoxine; ascorbic acid; biotin; tocoferol; vitamin Ki; vitamin K₂; menadione; their sodium, potassium, calcium, magnesium, or ammonium salt.

11. The formulation according to claim 1, wherein:
the at least one additive is the plant hormone; and the plant hormone comprises at least one of 2-(indol-3-yl) acetic acid; 2-(naphthalene-1-yl) acetic acid; 4-(indol-3-yl) butyric acid; abscisic acid; giberelinic acids; their ammonium, sodium, potassium, calcium or magnesium salts; or zeatin.

12. The formulation according to claim 1, wherein:
the at least one additive is the nitrogen fertilizer; and
the nitrogen fertilizer comprises at least one of urea, ammonium hydrogenphosphate, or sodium nitrate.

13. The formulation according to claim 1, wherein:
the at least one additive is the potassium salt; and
the potassium salt comprises at least one of potassium nitrate, potassium hydrogenphosphate, potassium chloride, potassium sulfate, potassium magnesium sulfate, or potassium thiosulfate.

14. The formulation according to claim 1, wherein:
the at least one additive is the borate salt; and
the borate salt comprises at least one of sodium borate; potassium borate; sodium tetraborate; potassium tetraborate; or their hydrates.

15. The formulation according to claim 1, wherein:
the at least one additive is the molybdate salt; and
the molybdate salt comprises at least one of sodium molybdate, potassium molybdate, or their hydrates.

16. The formulation according to claim 1, wherein:
the at least one additive is the plant extract; and the plant extract acts as natural source of minerals, vitamins, plant hormones, carbohydrates, higher fatty acids, amino-acids, and proteins.

17. The formulation according to claim 1, wherein:
the at least one additive is the plant extract; and
the plant extract comprises at least one of nettle, wheat, oat, barley, corn, seaweed, or chlorophyll.

18. The formulation according to claim 1, wherein the micronized zeolite acts as an enhancer of biological effects of the micronized calcite mineral in the synergistic manner; especially contributing to:
increased crop yields;
boosting of plant growth through stimulation of photosynthesis;
enhanced plant resistance to stress and diseases;
effective nutrition of plants with calcium, magnesium, iron, manganese, etc.; and
increased efficiency of basic fertilization through soil.

19. The formulation according to claim 1, wherein the formulation is used, as a plant booster and mineral fertilizer for improving crop yields, stimulation of plant growth, reinforcement of plant resistance to stress and diseases, improvement of nutrient absorption, and plant nutrition.

20. The formulation according to claim 1, wherein the formulation is used, as a plant booster and mineral fertilizer for treatment of vegetables, fruits, grape, flowers and ornamentals, cereals, turfs, and forests.
